(19) United States
(12) Patent Application Publication
(10) Pub. No.: US 2024/0054266 A1
(43) Pub. Date: Feb. 15, 2024

(54) SIMULATION METHOD, SIMULATION APPARATUS, AND NON-TRANSITORY COMPUTER READABLE MEDIUM STORING PROGRAM

(71) Applicant: SUMITOMO HEAVY INDUSTRIES, LTD., Tokyo (JP)

(72) Inventor: Masato Hirota, Yokosuka-shi (JP)

(21) Appl. No.: 18/298,356

(22) Filed: Apr. 10, 2023

(30) Foreign Application Priority Data
Aug. 12, 2022 (JP) 2022-129013

(51) Int. Cl. G06F 30/25; G06F 30/28

(52) U.S. Cl. CPC G06F 30/25; G06F 30/28; G06F 2113/08

(57) ABSTRACT

A simulation method of represents a fluid as a plurality of calculation particles, adds a physical quantity to each of the plurality of calculation particles, disposes the plurality of calculation particles in an analysis space, and develops the physical quantity added to each of the plurality of calculation particles and positions of the plurality of calculation particles over time by solving a governing equation. The simulation method includes evaluating an excess or deficiency of spatial resolution depending on sizes of the plurality of calculation particles, for each of the plurality of calculation particles, according to a state of a flow field represented by the plurality of calculation particles; and adjusting the spatial resolution, according to a result of the evaluation of the excess or deficiency of the spatial resolution.

### CROSS-REFERENCE TO RELATED APPLICATIONS

This application claims priority to Japanese Patent Application No. 2022-129013, filed on Aug. 12, 2022, which is incorporated by reference herein in its entirety.

### BACKGROUND

### Technical Field

A certain embodiment of present invention relates to a simulation method, a simulation apparatus, and a non-transitory computer readable medium storing a program.

### Description of Related Art

A simulation method for analyzing the behavior of a fluid by approximating the motion of the fluid as the motion of a particle system is known. This simulation method is called a particle method. In the particle method, the fluid is represented by a plurality of particles, and the wall boundary disposed in the flow field of the fluid is also generally represented by the plurality of particles.

### SUMMARY

According to one aspect of the present invention, there is provided a simulation method of representing a fluid as a plurality of calculation particles, adding a physical quantity to each of the plurality of calculation particles, disposing the plurality of calculation particles in an analysis space, and developing the physical quantity added to each of the plurality of calculation particles and positions of the plurality of calculation particles over time by solving a governing equation, the simulation method including: evaluating an excess or deficiency of spatial resolution depending on sizes of the plurality of calculation particles, for each of the plurality of calculation particles, according to a state of a flow field represented by the plurality of calculation particles; and adjusting the spatial resolution, according to a result of the evaluation of the excess or deficiency of the spatial resolution.

According to another aspect of the present invention, there is provided a simulation apparatus that analyzes a flow of a fluid using a particle method, including: an input unit to which a simulation condition is input; and a processing unit that develops a position of each of a plurality of particles over time by using the particle method, based on the simulation condition input to the input unit, in which the processing unit executes a procedure of representing the fluid as a plurality of calculation particles, adding a physical quantity to each of the plurality of calculation particles, disposing the plurality of calculation particles in an analysis space, and developing the physical quantity added to each of the plurality of calculation particles and positions of the plurality of calculation particles over time by solving a governing equation; a procedure of evaluating an excess or deficiency of spatial resolution depending on sizes of the plurality of calculation particles, for each of the plurality of calculation particles, according to a state of a flow field represented by the plurality of calculation particles; and a procedure of adjusting the spatial resolution, according to a result of the evaluation of the excess or deficiency of the spatial resolution.

According to still another aspect of the present invention, there is provided a non-transitory computer readable medium storing a program that causes a computer to execute a process for simulation that analyzes a flow of a fluid using a particle method, the process including: a procedure of representing the fluid as a plurality of calculation particles, adding a physical quantity to each of the plurality of calculation particles, disposing the plurality of calculation particles in an analysis space, and developing the physical quantity added to each of the plurality of calculation particles and positions of the plurality of calculation particles over time by solving a governing equation; a procedure of evaluating an excess or deficiency of spatial resolution depending on sizes of the plurality of calculation particles, for each of the plurality of calculation particles, according to a state of a flow field represented by the plurality of calculation particles; and a procedure of adjusting the spatial resolution, according to a result of the evaluation of the excess or deficiency of the spatial resolution.

### BRIEF DESCRIPTION OF THE DRAWINGS

FIG. 1 is a block diagram of a simulation apparatus according to one embodiment.

FIG. 2 is a flowchart showing procedures of a simulation method according to the present embodiment.

FIG. 3 is a schematic diagram showing an analysis space and a plurality of calculation particles disposed in the analysis space.

FIG. 4 is a flowchart showing procedures of a method of evaluating spatial resolution.

FIG. 5 is a schematic diagram showing a positional relationship between a wall surface and calculation particles to be evaluated.

FIG. 6 is a flowchart showing procedures of a spatial resolution adjustment method executed in step SA6 of FIG. 2.

FIG. 7A is a schematic diagram of a calculation particle before division, and FIG. 7B is a schematic diagram of two calculation particles generated by dividing one calculation particle.

FIG. 8A is a schematic diagram of four calculation particles generated by dividing one calculation particle, and FIG. 8B is a schematic diagram of eight calculation particles generated by dividing one calculation particle.

FIG. 9A is a schematic diagram showing an example of the distribution of a plurality of calculation particles, and FIG. 9B is a schematic diagram showing an example of the distribution of the calculation particles after two calculation particles are combined.

FIG. 10A is a schematic diagram showing a distribution of a plurality of calculation particles before the calculation particle is divided, FIG. 10B is a schematic diagram showing a distribution of a plurality of calculation particles after one calculation particle is divided, and FIG. 10C is a schematic diagram showing a distribution of the plurality of calculation particles at a time when a certain number of time steps have elapsed from the state shown in FIG. 10B.

FIG. 11A is a schematic diagram showing a distribution of a plurality of calculation particles before two calculation particles are combined, FIG. 11B is a schematic diagram showing a distribution of the plurality of calculation particles after the two calculation particles are combined, and FIG. 11C is a schematic diagram showing a distribution of the plurality of calculation particles at a time when a certain number of time steps have elapsed from the state shown in FIG. 11B.

FIG. 12 is a flowchart showing procedures of a simulation method according to another embodiment.

FIG. 13 is a schematic diagram of an analysis model that has actually been simulated.

FIGS. 14A and 14B are schematic diagrams showing distributions of calculation particles at a calculation start time and a calculation end time, respectively.

FIG. 15 is a graph showing a velocity distribution at the calculation end time and a velocity distribution in an initial state.

### DETAILED DESCRIPTION

In fluid analysis using the particle method, spatial resolution is determined by the diameter of the particle. The particle diameter needs to be set sufficiently small with respect to the length scale of the fluid motion to be analyzed. In general, the length scale of fluid motion varies from place to place. For example, in a region far from the wall of an object disposed in the fluid, analysis with sufficiently high accuracy can be performed even when the diameter of the particle is increased. However, in the vicinity of the wall, the length scale of the fluid motion is represented by the thickness of the boundary layer. Therefore, in order to accurately analyze the motion of the fluid in the vicinity of the wall, the diameter of the particles needs to be sufficiently smaller than the thickness of the boundary layer.

In order to perform highly accurate analysis in the entire analysis space, it is necessary to reduce the diameter of the particles in accordance with the thickness of the boundary layer even in a region far from the wall. Therefore, the number of particles to be disposed in the analysis space increases, and as a result, the amount of calculation increases.

It is desirable to provide a simulation method, a simulation apparatus, and a non-transitory computer readable medium storing a program capable of maintaining high analysis accuracy and reducing a calculation amount in an analysis using a particle method.

By adjusting the spatial resolution, according to a result of the evaluation of excess or deficiency of the spatial resolution, the analysis can be performed with an appropriate spatial resolution in the entire analysis space.

Before describing an embodiment of the present invention, a general SPH (Smoothed Particle Hydrodynamics) method will be briefly described. The SPH method is a Lagrange-type numerical calculation method that discretizes a continuum using a set of a plurality of calculation particles and calculates the flow field developed over time. In the SPH method, a continuous and differentiable kernel function is used as the mass distribution of one particle, and a discrete model is used in which spatial derivative is the superposition of the differential coefficients of the kernel function.

In the SPH method, the masses m of the calculation particles are distributed around the calculation particle according to the kernel function W and are continuously distributed, and the density field is given as the superposition thereof. That is, the density ρₛ at the position xₛ of the s-th calculation particle is expressed by the following expression.

$${ρ}_{s} = ρ ( {x}_{s} ) = {\sum }_{m} {m}_{m} W ( {x}_{sm} , h ) \qquad ( 1 )$$

$${x}_{s m} = ‖ {x}_{s} - {x}_{m} ‖$$

In the present specification, the subscripts s and m represent the serial numbers assigned to the calculation particles, and the physical quantities with the subscripts s and m mean physical quantities attached to the s-th and m-th calculation particles, respectively.

For example, the following functions can be used as the kernel function W. The following function is called a C2 Wendland kernel.

$$W ( {x}_{sm} , h ) = W ( q ) = \{ \begin{matrix}\frac{21}{16 π {h}^{3}} {( 1 - \frac{q}{2} )}^{4} ( 1 + 2 q ) , & ( 0 \leq q \leq 2 ) \\ 0 , & ( 2 < q )\end{matrix} \qquad ( 2 )$$

$$q = \frac{{x}_{s m}}{h}$$

h is a smoothing length, and is also called a kernel width. The kernel width h is equal to the diameter of an equivalent sphere in which a plurality of particles are replaced with spheres having the same mass and physical property density. In the present specification, the kernel width h may be referred to as a particle diameter.

The values of any scalar quantity A and vector quantity A at any position xₛ can be expressed by the following expression by superimposing the kernel functions.

$$A ( {x}_{s} ) = {\sum }_{m} {V}_{m} {A}_{m} W ( {x}_{sm} , h ) \qquad ( 3 )$$

$$A ( {x}_{s} ) = {\sum }_{m} {V}_{m} {A}_{m} W ( {x}_{sm} , h )$$

$${V}_{m} = \frac{{m}_{m}}{{ρ}_{m}}$$

The gradient of the any scalar quantity A is expressed by the following expression by superimposing the differential coefficients of the kernel function.

$$∇ A ( {x}_{s} ) = {\sum }_{m} {V}_{m} {A}_{m} {∇}_{s} W ( {x}_{sm} , h ) \qquad ( 4 )$$

$${∇}_{s} W ( {x}_{sm} , h ) = \frac{{x}_{s} - {x}_{m}}{{x}_{s m}} ∇ W ( {x}_{s m} , h ) \qquad ( 5 )$$

Here, ∇W (xₛₘ, h) is a derivative of the kernel

function, and is expressed by the following expression when a C2 Wendland kernel is used as the kernel function.

$$∇ W ( {x}_{sm} , h ) = ∇ W ( q ) = \{ \begin{matrix}- \frac{105}{16 π {h}^{4}} {q ( 1 - \frac{q}{2} )}^{3} , & ( 0 \leq q \leq 2 ) \\ 0 , & ( 2 < q )\end{matrix} \qquad ( 6 )$$

Since the function W(q) in Expression (2) is a function of one variable, the gradient ∇W thereof is a scalar quantity.

The divergence for any vector quantity A can be expressed by the following expression, as in Expression (6).

$$∇ \cdot A ( {x}_{s} ) = {\sum }_{m} {V}_{m} {A}_{m} \cdot {∇}_{s} W ( {x}_{sm} , h ) \qquad ( 7 )$$

The quadratic derivative for any scalar quantity A can be calculated using, for example, the following expression.

$${∇}^{2} A ( {x}_{s} ) = 2 {\sum }_{m} {V}_{m} \frac{{A}_{s} - {A}_{m}}{{x}_{s m}} ( {e}_{s m} \cdot {∇}_{s} W ( {x}_{sm} , h ) ) \qquad ( 8 )$$

$${e}_{s m} = \frac{{x}_{s} - {x}_{m}}{{x}_{s m}}$$

### Flow Governing Equation

Next, the governing equation when the compressible flow is to be analyzed will be described. For example, Reynolds-Averaged Navier-Stokes (RANS) analysis can be used as a means for analyzing a compressible flow having a high Reynolds number with limited computational resources. This is a technique for decomposing the flow governing equation into an average field and a fluctuation field by Reynolds decomposition, modeling the contribution of the fluctuation field to the average field, and numerically solving only the governing equation of the average field to analyze the average field of a high Reynolds number flow with less computational resources.

As a formulating method for BANS analysis, for example, a Shear Stress Transport (SST) model can be used. SST models are described in F. R. MENTER, “Two-equation eddy-viscosity turbulence models for engineering applications”, AIAA Journal Vol. 32 No. 8, (1994), pp. 1598-1605, _eprint: https://doi.org/10.2514/3.12149.

The governing equation of the compressible flow using the SST model can be described as follows, for example.

$$\frac{D ρ}{D t} = - ρ \frac{\partial {v}_{i}}{\partial {x}_{i}} \qquad ( 9 )$$

$$ρ \frac{D {v}_{i}}{D t} = - \frac{\partial p}{\partial {x}_{i}} + \frac{\partial }{\partial {x}_{j}} [ {σ}_{ij} + {τ}_{i j} ] \qquad ( 10 )$$

$$ρ \text{} \frac{D u}{D t} = \text{} - \frac{\partial {pv}_{i}}{\partial {x}_{i}} + \text{} \frac{\partial }{\partial {x}_{j}} [ {v}_{i} {σ}_{ij} + {v}_{i} {τ}_{ij} ] - \frac{\partial }{\partial {x}_{j}} [ - ( \frac{{c}_{p} μ}{P r} + \frac{{c}_{p} {μ}_{t}}{{Pr}_{t}} ) \frac{\partial T}{\partial {x}_{j}} ] \qquad ( 11 )$$

$$ρ \frac{D k}{D t} = {τ}_{ij} \frac{\partial {v}_{i}}{\partial {x}_{j}} - {β}^{*} ρ ω k + \frac{\partial }{\partial {x}_{j}} [ ( μ + {σ}_{k} {μ}_{t} ) \frac{\partial k}{\partial {x}_{j}} ] \qquad ( 12 )$$

$$ρ \frac{D ω}{D t} = \text{} \frac{γ}{{v}_{t}} {τ}_{ij} \frac{\partial {u}_{i}}{\partial {x}_{j}} - βρ {ω}^{2} + \frac{\partial }{\partial {x}_{j}} [ ( μ + {σ}_{ω} {μ}_{t} ) \frac{\partial ω}{\partial {x}_{j}} ] + 2 ρ ( 1 - {F}_{1} ) {σ}_{ω 2} \frac{1}{ω} \frac{\partial k}{\partial {x}_{j}} \frac{\partial ω}{\partial {x}_{i}} \qquad ( 13 )$$

Here, t represents time, x represents spatial coordinates, ρ represents density, v represents velocity, p represents pressure, u represents internal energy, and T represents temperature. The subscripts i, j, and k represent components of a vector quantity or a tensor quantity. k and Ω are variables of the SST model, k is the kinetic energy of the turbulent flow, and Ω is a quantity corresponding to the dissipation time scale of the kinetic energy of the turbulent flow. cₚ is the low pressure specific heat, and Pr represents the Prandtl number.

σᵢⱼ represents a viscous stress tensor and is given by the following expression.

$${σ}_{ij} = 2 μ ( {S}_{i j} - \frac{1}{3} \frac{\partial {v}_{k}}{\partial {x}_{k}} {δ}_{ij} ) \qquad ( 14 )$$

Here, Sᵢⱼ represents a distortion rate tensor. μ is a viscosity coefficient, and can be calculated using, for example, Sutherland's equation. δᵢⱼ represents δ of Kronecker. τᵢⱼ is a Reynolds stress term, and is often expressed by the following expression.

$${τ}_{ij} = 2 {μ}_{t} ( {S}_{i j} - \frac{1}{3} \frac{\partial {v}_{k}}{\partial {x}_{k}} {δ}_{ij} ) - \frac{2}{3} ρ k {δ}_{ij} \qquad ( 15 )$$

Here, μₜ is a vortex viscosity coefficient. The pressure p can be calculated using, for example, the following expression of state of the ideal gas.

p=ρRT (16)

Here, R is a gaseous number.

Other variables in Expressions (9) to (13) are constants used in the SST model. Since the SST model is generally widely used, description of these constants will be omitted here.

By discretizing and numerically solving Expressions (9) to (13) by using Expression (4), it is possible to analyze the compressible flow with a high Reynolds number using the SPH method.

The governing equation discretized by the SPH method is described as follows.

$$\frac{D {x}_{i}}{D t} {\vert}_{s} = {[ {v}_{i} + δ {v}_{i} ]}_{s} \qquad ( 17 )$$

$$\frac{D ρ}{D t} {\vert}_{s} = {{[ - p \frac{\partial {v}_{i}}{\partial {x}_{i}} ]}_{s}}_{s} \qquad ( 18 )$$

$$ρ \frac{D {v}_{i}}{D t} {\vert}_{s} = {[ - \frac{\partial p}{\partial {x}_{i}} + \frac{\partial }{\partial {x}_{\}}} [ {σ}_{i j} + {τ}_{ij} ] ]}_{s} \qquad ( 19 )$$

$$ρ \frac{D u}{D t} {\vert}_{s} = {[ - \frac{\partial {pv}_{i}}{\partial {x}_{i}} + \frac{\partial }{\partial {x}_{j}} [ {v}_{i} {σ}_{ij} + {v}_{i} {τ}_{ij} ] - \frac{\partial }{\partial {x}_{j}} [ - ( \frac{{c}_{p} μ}{Pr} + \frac{{c}_{p} {μ}_{t}}{{Pr}_{t}} ) \frac{\partial T}{\partial {x}_{j}} ] ]}_{s} \qquad ( 20 )$$

$$ρ \frac{D k}{Dt} {\vert}_{s} = {[ {τ}_{ij} \frac{\partial {v}_{i}}{\partial {x}_{j}} - {β}^{*} ρω k + \frac{\partial }{\partial {x}_{j}} [ ( μ + {σ}_{k} {μ}_{t} ) \frac{\partial k}{\partial {x}_{j}} ] ]}_{s} \qquad ( 21 )$$

$$ρ \frac{D ω}{Dt} {\vert}_{s} = [ \frac{γ}{{v}_{t}} {τ}_{ij} \frac{\partial {u}_{i}}{\partial {x}_{j}} - {βρω}^{2} + \frac{\partial }{\partial {x}_{j}} [ ( μ + {σ}_{ω} {μ}_{t} ) \frac{\partial ω}{\partial {x}_{j}} ] \text{} + \text{} 2 ρ ( 1 - {F}_{1} ) {σ}_{ω2} \frac{1}{ω} \frac{\partial k}{\partial {x}_{j}} \frac{\partial ω}{\partial {x}_{j}} {\vert}_{s} \qquad ( 22 )$$

Here, δvᵢ is an artificial translocation term for equalizing the non-uniformity of the spatial distribution of the calculation particles.

For example, the following expression can be used as the artificial translocation term δvᵢ.

$$δ {v}_{s}^{*} = {c}_{0} ( 2 {\overline{h}}_{s m} ) {\sum }_{m} {V}_{m} [ 1.0 + S {( \frac{W ( {x}_{sm} , {h}_{m} )}{W ( {h}_{m} , {h}_{t 𝔫} )} )}^{κ} ] {∇}_{s} {W}_{s m} \qquad ( 23 )$$

$${\overline{h}}_{sm} = \frac{{h}_{s} + {h}_{m}}{2}$$

$$δ {v}_{s} = min ( ‖ {δv}_{s}^{*} ‖ , \frac{{c}_{0}}{2} ) \frac{δ {v}_{s}^{*}}{‖ {δv}_{s}^{*} ‖} \qquad ( 24 )$$

Here, S and κ are parameters indicating the strength of the artificial translocation term. For example, S=0.4 and κ=4 can be set. c₀ is a representative sound velocity. As the representative sound velocity c₀, the sound velocity under the stagnation point condition can be used.

### Excess or Deficiency of Spatial Resolution

Next, the excess or deficiency of the spatial resolution in the case of analyzing the flow field by using the particle method will be described. In fluid analysis using the particle method such as the SPH method, the spatial resolution of the analysis is determined by the diameter of the calculation particle (for example, the kernel width). In general, the length scale of fluid motion varies from place to place. For example, in the vicinity of a wall surface of an object, a length scale of fluid motion is represented by a boundary layer thickness, and relatively high spatial resolution is required.

On the other hand, in a region where the distance from the wall surface is long, the length scale of the fluid motion is often larger than the boundary layer thickness. Therefore, in a region where the distance from the wall surface is long, analysis can be performed with a lower spatial resolution than in a region near the wall surface.

When a calculation particle having a large diameter is disposed in a region where analysis needs to be performed with a high spatial resolution, the spatial resolution of the analysis becomes insufficient. On the contrary, when the calculation particles having small diameters are disposed in a region where the analysis can be performed with a low spatial resolution, the spatial resolution of the analysis becomes excessive. In the embodiment described below, excess or deficiency of the spatial resolution of the analysis can be reduced, and the analysis can be performed with the necessary and sufficient spatial resolution.

### Simulation Procedure According to Embodiment

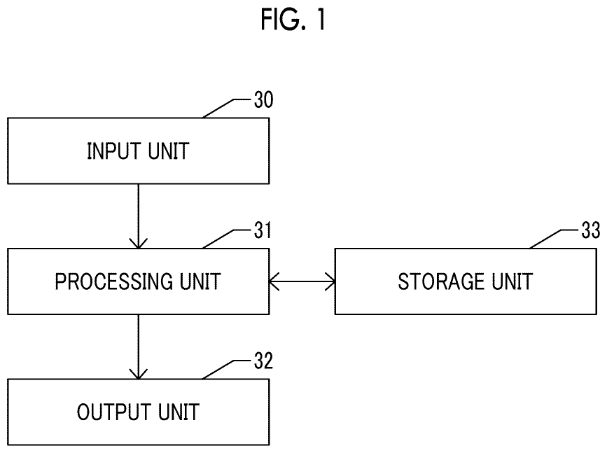

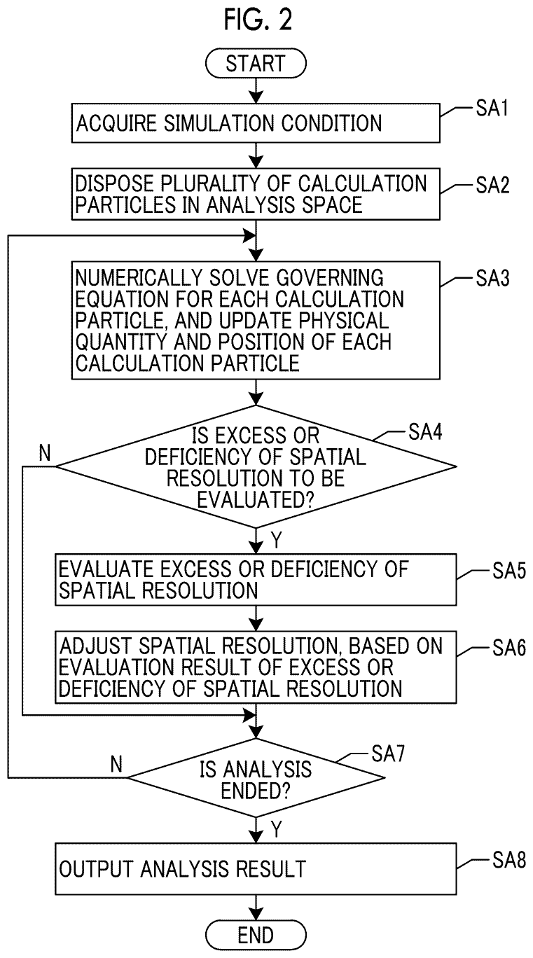

A simulation apparatus and a simulation method according to the present embodiment will be described with reference to FIGS. 1 and 2.

FIG. 1 is a block diagram of a simulation apparatus according to the present embodiment. The simulation apparatus according to the embodiment includes an input unit 30, a processing unit 31, an output unit 32, and a storage unit 33. Simulation conditions and the like are input from the input unit 30 to the processing unit 31. Further, various commands are input from the user to the input unit 30. The input unit 30 includes, for example, a communication device, a removable media reading device, a keyboard, a pointing device, or the like.

The processing unit 31 executes a simulation by the particle method, based on the input simulation conditions and commands. Further, the simulation result is output to the output unit 32. The simulation result includes information representing the state of the particles in the particle system which is to be simulated, the temporal change of the physical quantity of the particle system, and the like. Examples of the processing unit 31 include a central processing unit (CPU) of a computer. A program for causing the computer to execute the simulation by the particle method is stored in the storage unit 33. The output unit 32 includes a communication device, a removable media writing device, a display, and the like.

FIG. 2 is a flowchart showing procedures of the simulation method according to the present embodiment.

First, the processing unit 31 acquires the simulation conditions input to the input unit 30 (step SA1). The simulation conditions include, for example, information defining a fluid to be simulated, boundary conditions, initial conditions, and the like. The information defining the fluid includes physical property values such as density and viscosity of the fluid. The boundary condition includes information that designates the shape and size of the analysis space. The initial conditions include a method of designating an initial physical property value of the fluid, an initial value of a kernel width of the calculation particle, and information for disposing the plurality of calculation particles in the analysis space.

The simulation conditions further include an evaluation index for excess or deficiency of spatial resolution, a method for dividing the calculation particles, and information for designating the maximum kernel width. This information is referred to in the simulation of the present embodiment to be described below.

Next, the processing unit 31 disposes a plurality of calculation particles in the analysis space based on the acquired simulation conditions (step SA2).

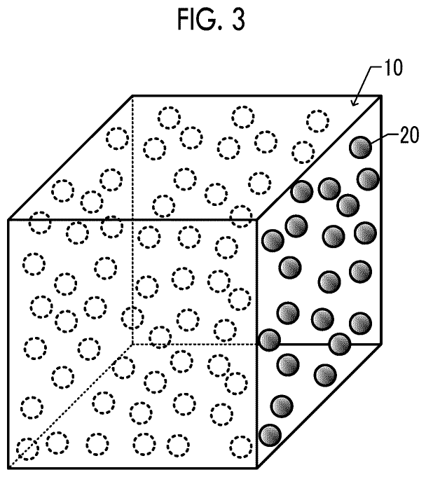

FIG. 3 is a schematic diagram showing the analysis space 10 and the plurality of calculation particles 20 disposed in the analysis space 10. As an example, the analysis space 10 has a rectangular shape, and conditions such as non-slip conditions and periodic boundary conditions are imposed to each surface of the analysis space 10.

Next, the physical quantity added to each of the calculation particles 20 is calculated by numerically solving the governing equations shown in Expressions (17) to (22) for each of the plurality of calculation particles 20, and the physical quantity and position of each of the calculation particles 20 are updated (step SA3).

Next, it is determined whether or not to evaluate the excess or deficiency of the spatial resolution (step SA4). For example, the processing unit 31 determines to evaluate the excess or deficiency of the spatial resolution, at a time when a certain number of time steps have elapsed from the latest time step in which the excess or deficiency of the spatial resolution is evaluated.

In a case where it is determined to evaluate the excess or deficiency of the spatial resolution, the processing unit 31 evaluates the excess or deficiency of the spatial resolution (step SA5). For example, when the diameter of the calculation particle 20 is significantly larger compared to the spatial resolution required for the analysis, the spatial resolution is determined to be insufficient. On the contrary, when the diameter of the calculation particle 20 is significantly smaller compared to the spatial resolution required for the analysis, it is determined that the spatial resolution is excessive.

After evaluating the excess or deficiency of the spatial resolution, the processing unit 31 adjusts the spatial resolution based on the evaluation result (step SA6). For example, in a region where the spatial resolution is determined to be insufficient, the spatial resolution is increased by making the diameter of the calculation particle 20 smaller than the current diameter. At this time, the number of the calculation particles 20 is increased as the diameter of the calculation particles 20 is reduced. In a region where the spatial resolution is determined to be excessive, the spatial resolution is lowered by making the diameter of the calculation particle 20 larger than the current diameter. At this time, the number of the calculation particles 20 is reduced as the diameter of the calculation particles 20 is increased.

When it is determined not to evaluate the excess or deficiency of the spatial resolution in step SA4, steps SA5 and SA6 are not executed.

The processes after step SA3 are repeatedly executed until the analysis end condition is satisfied (step SA7). The analysis end condition is defined by, for example, the number of time steps to be executed. When the analysis is completed, the analysis result is output to the output unit 32 (step SA8).

### Evaluation of Excess or Deficiency of Spatial Resolution

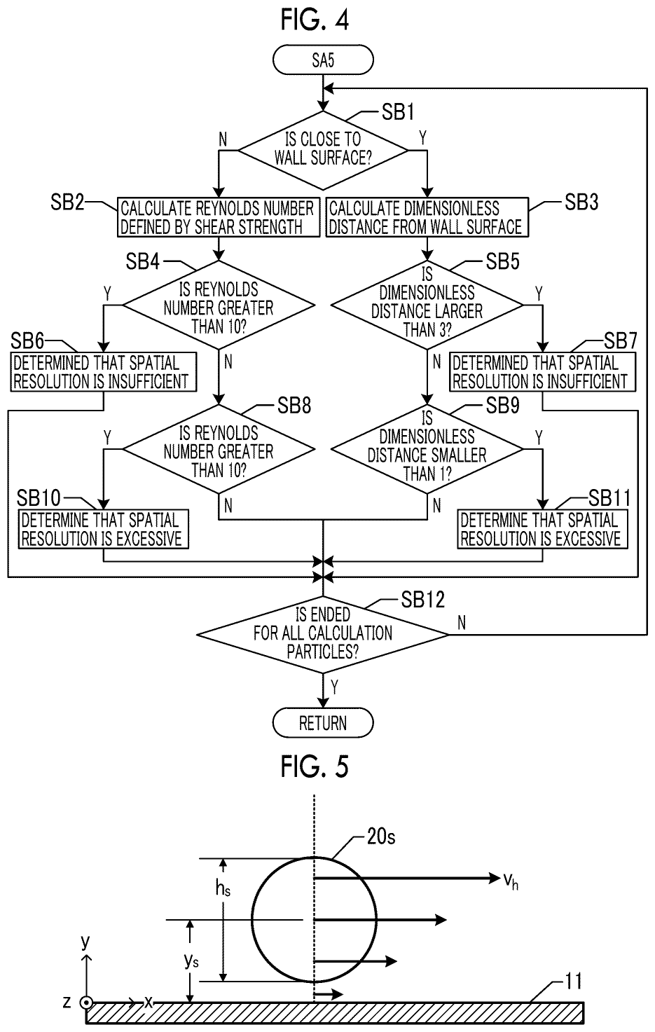

Next, an example of the spatial resolution evaluation method executed in step SA5 (FIG. 2) will be described with reference to FIGS. 4 and 5.

FIG. 4 is a flowchart showing procedures of a method of evaluating the spatial resolution. This evaluation is performed for each of the plurality of calculation particles 20.

First, it is determined whether or not the calculation particle 20 to be evaluated is close to the wall surface (step SB1). Here, among the wall surfaces of the analysis space 10 shown in FIG. 3, the wall surface to which the periodic boundary condition is applied is not included in the wall surface to be determined. For example, a determination is made for a wall surface to which the non-slip condition is applied.

FIG. 5 is a schematic diagram showing a positional relationship between the wall surface 11 and the calculation particles 20s to be evaluated. A xyz orthogonal coordinate system is defined in which the surface of the wall surface 11 is an xz plane and the normal direction of the wall surface 11 is the y-direction. The diameter of the calculation particles 20s is marked as hₛ, and the distance from the wall surface 11 to the center of the calculation particles 20s is marked as yₛ. As an example, the calculation particles 20s satisfying yₛ<hₛ are determined to be particles located in the vicinity of the wall surface 11. A component parallel to the wall surface 11 of the velocity vector of the fluid is marked as vₕ. In the vicinity of the wall surface 11, the velocity vₕ increases as the distance from the wall surface 11 increases.

For the calculation particles 20s that are not close to the wall surface, the Reynolds number Re_{γs} defined by the shear strength γ dots at the center position of the calculation particles 20s is calculated using the following expression (step SB2).

$${Re}_{γ s} = \frac{{ρ}_{s} {h}_{s}^{2} {\dot{γ}}_{s}}{{μ}_{s} + {μ}_{t s}} \qquad ( 25 )$$

Here, the shear strength γ dot can be calculated using the following expression.

$$\dot{γ} = \sqrt{\begin{matrix}2 {( \frac{\partial {v}_{x}}{\partial x} )}^{2} + 2 {( \frac{\partial {v}_{y}}{\partial y} )}^{2} + 2 {( \frac{\partial {v}_{z}}{\partial z} )}^{2} + \\ {( \frac{\partial {v}_{x}}{\partial y} + \frac{\partial {v}_{y}}{\partial x} )}^{2} + {( \frac{\partial {v}_{x}}{\partial z} + \frac{\partial {v}_{z}}{\partial x} )}^{2} + {( \frac{\partial {v}_{y}}{\partial z} + \frac{\partial {v}_{z}}{\partial y} )}^{2}\end{matrix}} \qquad ( 26 )$$

Here, vₓ, v_{y}, and v_{z} represent the x component, the y component, and the z component of the velocity vector of the calculation particle 20, respectively.

After calculating the Reynolds number Re_{γs} at the position of the calculation particles 20s, the processing unit 31 determines whether or not the Reynolds number Re_{γs} is greater than 10 (step SB4). When the Reynolds number Re_{γs} is larger than 10, it is determined that the spatial resolution at the position of the calculation particles 20s is insufficient (step SB6). When the Reynolds number Re_{γs} is 10 or less, the processing unit 31 determines whether or not the Reynolds number Re_{γs} is smaller than 2.5 (step SB8). When the Reynolds number Re_{γs} is smaller than 2.5, it is determined that the spatial resolution at the position of the calculation particles 20s is excessive (step SB10). In the present specification, the spatial resolution at the position of the calculation particle may be simply referred to as “spatial resolution of the calculation particle”.

When the calculation particles 20s are close to the wall surface 11, the processing unit 31 calculates a dimensionless distance yₛ⁺ from the wall surface 11 to the center of the calculation particles 20s by the following expression (step SB3).

$${y}_{s}^{+} = \frac{{ρ}_{s} {y}_{s} {v}_{τs}}{{μ}_{s} + {μ}_{t s}} \qquad ( 27 )$$

Here, v_{τs} is the wall surface friction velocity and is expressed by the following expression.

$${v}_{τ s} = \sqrt{\frac{{τ}_{w s}}{{ρ}_{s}}} \qquad ( 28 )$$

$${τ}_{w s} = {μ}_{s} \frac{\partial {v}_{h}}{\partial y} {\vert}_{y = 0} \qquad ( 29 )$$

Here, τ_{w} represents the frictional stress acting on the wall surface 11. For the calculation particles 20s located in the vicinity of the wall surface 11, the wall surface frictional stress τ_{ws} can be approximately calculated by the following expression using the velocity gradient at the position of the calculation particles 20s.

$${τ}_{w s} = {μ}_{s} \frac{\partial {v}_{h}}{\partial y} {\vert}_{y = {y}_{s}} \qquad ( 30 )$$

When the dimensionless distance yₛ⁺ is obtained for the calculation particle 20s, the processing unit 31 determines whether or not the dimensionless distance yₛ⁺ is larger than 3 (step SB5). When the dimensionless distance yₛ⁺ is larger than 3, it is determined that the spatial resolution of the position of the calculation particle 20s is insufficient (step SB7). When the dimensionless distance yₛ⁺ is 3 or less, the processing unit 31 determines whether or not the dimensionless distance yₛ⁺ is smaller than 1 (step SB9). When the dimensionless distance yₛ⁺ is smaller than 1, the processing unit 31 determines that the spatial resolution of the calculation particles 20s is excessive (step SB11).

The above step of determining the excess or deficiency of the spatial resolution is repeated for all the calculation particles 20 (step SB12).

### Spatial Resolution Adjustment Method

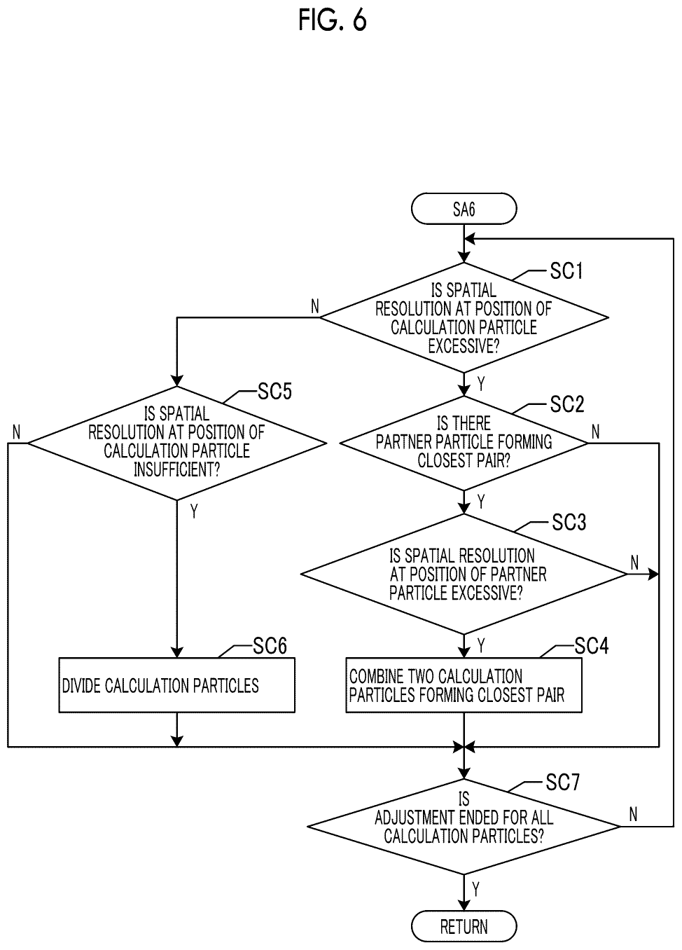

Next, an example of the spatial resolution adjustment method executed in step SA6 (FIG. 2) will be described with reference to FIGS. 6 to 9B.

FIG. 6 is a flowchart showing procedures of the spatial resolution adjustment method executed in step SA6 (FIG. 2). This adjustment is performed for each of the plurality of calculation particles 20.

Based on the evaluation result performed in step SA5, the processing unit 31 determines whether or not the spatial resolution of the calculation particle 20 of interest is excessive (step SC1). In a case where it is determined that the spatial resolution is not excessive, it is determined whether or not the spatial resolution of the calculation particle 20 is insufficient (step SC5). When the spatial resolution of the calculation particles 20 is insufficient, the calculation particles 20 are divided (step SC6) to generate a plurality of calculation particles having a smaller kernel width.

In a case where one calculation particle 20 is divided into a plurality of calculation particles 20, it is necessary to store physical quantities such as mass and volume of the calculation particle 20. In addition, any number and disposition of the plurality of calculation particles 20 after the division are available.

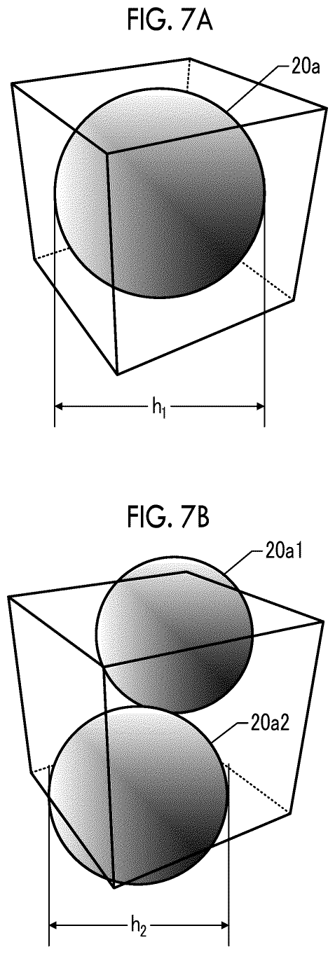

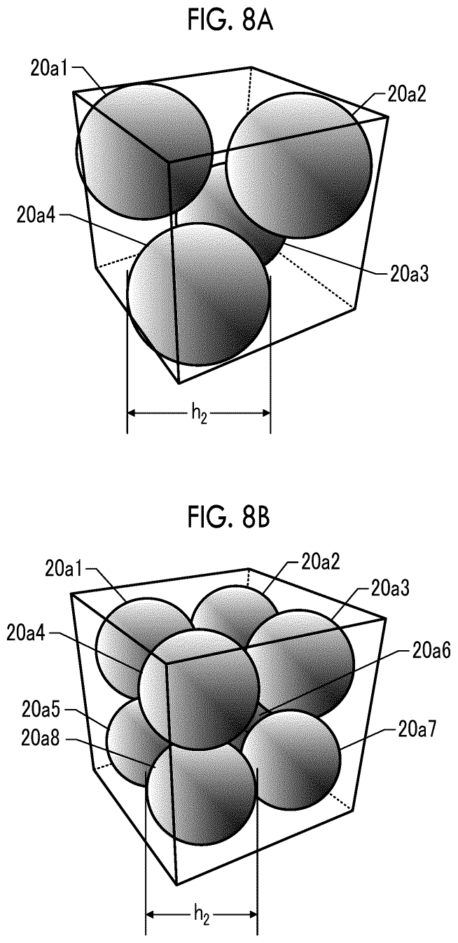

FIG. 7A is a schematic diagram of the calculation particles 20a before the division. FIG. 7B is a schematic diagram of two calculation particles 20a1 and 20a2 generated by dividing one calculation particle 20a. FIG. 8A is a schematic diagram of four calculation particles 20a1 to 20a4 generated by dividing one calculation particle 20a. FIG. 8B is a schematic diagram of eight calculation particles 20a1 to 20a8 generated by dividing one calculation particle 20a.

First, as shown in FIG. 7B, a case where the calculation particle is divided into two calculation particles 20a1 and 20a2 will be described. With respect to the calculation particle 20a before division, the position is marked as x₁, the kernel width is marked as h₁, the mass is marked as m₁, and the volume is marked as V₁. With respect to each of the two calculation particles 20a1 and 20a2 after the division, the kernel width is marked as h₂, the mass is marked as m₂, and the volume is marked as V₂. The positions of the two calculation particles 20a1 and 20a2 after the division are marked as x₂₁ and x₂₂, respectively. Here, V₁=h₁³ and V₂=h₂³.

The mass m₂, the volume V₂, and the kernel width h₂ of each of the calculation particles 20a1 and 20a2 after the division can be calculated by the following expressions.

$${m}_{2} = \frac{1}{2} {m}_{1} \qquad ( 31 )$$

$${V}_{2} = \frac{1}{2} {V}_{1}$$

$${h}_{2} = {V}_{2}^{1 / 3} = {( \frac{1}{2} {V}_{1} )}^{1 / 3} ≅ 0.79 {h}_{1}$$

The positions x₂₁ and x₂₂ of the two calculation particles 20a1 and 20a2 after the division can be given by, for example, the following expression.

$${x}_{21} = {x}_{1} + \frac{1}{2} ( {h}_{1} - {h}_{2} ) i + \frac{1}{2} ( {h}_{1} - {h}_{2} ) j + \frac{1}{2} ( {h}_{1} - {h}_{2} ) k \qquad ( 32 )$$

$${x}_{22} = {x}_{1} - \frac{1}{2} ( {h}_{1} - {h}_{2} ) i - \frac{1}{2} ( {h}_{1} - {h}_{2} ) j - \frac{1}{2} ( {h}_{1} - {h}_{2} ) k$$

Here, the vectors i, j, and k represent unit vectors in the x-direction, the y-direction, and the z-direction of the xyz orthogonal coordinate system defined in the analysis space 10 (FIG. 3), respectively.

Next, a case where the calculation particle is divided into four calculation particles 20a1 to 20a4 will be described as shown in FIG. 8A. With respect to each of the four calculation particles 20a1 to 20a4 after the division, the kernel width is marked as h₂, the mass is marked as m₂, and the volume is marked as V₂. The positions of the four calculation particles 20a1 to 20a4 after the division are marked as x₂₁ to x₂₄, respectively.

The mass m₂, the volume V₂, and the kernel width h₂ of each of the calculation particles 20a1 to 20a4 after the division can be calculated by the following expressions.

$${m}_{2} = \frac{1}{4} {m}_{1} \qquad ( 33 )$$

$${V}_{2} = \frac{1}{4} {V}_{1}$$

$${h}_{2} = {V}_{2}^{1 / 3} = {( \frac{1}{4} {V}_{1} )}^{1 / 3} ≅ 0.63 {h}_{1}$$

The positions x₂₁ to x₂₄ of the four calculation particles 20a1 to 20a4 after the division can be given by, for example, the following expression.

$${x}_{21} = {x}_{1} + \frac{1}{2} ( {h}_{1} - {h}_{2} ) i + \frac{1}{2} ( {h}_{1} - {h}_{2} ) j - \frac{1}{2} ( {h}_{1} - {h}_{2} ) k \qquad ( 34 )$$

$${x}_{22} = {x}_{1} - \frac{1}{2} ( {h}_{1} - {h}_{2} ) i - \frac{1}{2} ( {h}_{1} - {h}_{2} ) j - \frac{1}{2} ( {h}_{1} - {h}_{2} ) k$$

$${x}_{23} = {x}_{1} - \frac{1}{2} ( {h}_{1} - {h}_{2} ) i + \frac{1}{2} ( {h}_{1} - {h}_{2} ) j + \frac{1}{2} ( {h}_{1} - {h}_{2} ) k$$

$${x}_{24} = {x}_{1} + \frac{1}{2} ( {h}_{1} - {h}_{2} ) i - \frac{1}{2} ( {h}_{1} - {h}_{2} ) j + \frac{1}{2} ( {h}_{1} - {h}_{2} ) k$$

Next, a case where the calculation particle is divided into eight calculation particles 20a1 to 20a8 will be described as shown in FIG. 8B. With respect to each of the eight calculation particles 20a1 to 20a8 after the division, the kernel width is marked as h₂, the mass is marked as m₂, and the volume is marked as V₂. The positions of the eight calculation particles 20a1 to 20a8 after the division are marked as x₂₁ to x₂₈, respectively.

The mass m₂, the volume V₂, and the kernel width h₂ of each of the calculation particles 20a1 to 20a8 after the division can be calculated by the following expressions.

$${m}_{2} = \frac{1}{8} {m}_{1} \qquad ( 35 )$$

$${V}_{2} = \frac{1}{8} {V}_{1}$$

$${h}_{2} = {V}_{2}^{1 / 3} = {( \frac{1}{8} {V}_{1} )}^{1 / 3} = 0.5 {h}_{1}$$

The positions x₂₁ to x₂₈ of the eight calculation particles 20a1 to 20a8 after the division can be given by, for example, the following expression.

$${x}_{21} = {x}_{1} + \frac{1}{2} ( {h}_{1} - {h}_{2} ) i + \frac{1}{2} ( {h}_{1} - {h}_{2} ) j + \frac{1}{2} ( {h}_{1} - {h}_{2} ) k \qquad ( 36 )$$

$${x}_{22} = {x}_{1} - \frac{1}{2} ( {h}_{1} - {h}_{2} ) i + \frac{1}{2} ( {h}_{1} - {h}_{2} ) j + \frac{1}{2} ( {h}_{1} - {h}_{2} ) k$$

$${x}_{23} = {x}_{1} + \frac{1}{2} ( {h}_{1} - {h}_{2} ) i - \frac{1}{2} ( {h}_{1} - {h}_{2} ) j + \frac{1}{2} ( {h}_{1} - {h}_{2} ) k$$

$${x}_{24} = {x}_{1} - \frac{1}{2} ( {h}_{1} - {h}_{2} ) i - \frac{1}{2} ( {h}_{1} - {h}_{2} ) j + \frac{1}{2} ( {h}_{1} - {h}_{2} ) k$$

$${x}_{25} = {x}_{1} + \frac{1}{2} ( {h}_{1} - {h}_{2} ) i + \frac{1}{2} ( {h}_{1} - {h}_{2} ) j - \frac{1}{2} ( {h}_{1} - {h}_{2} ) k$$

$${x}_{26} = {x}_{1} - \frac{1}{2} ( {h}_{1} - {h}_{2} ) i + \frac{1}{2} ( {h}_{1} - {h}_{2} ) j - \frac{1}{2} ( {h}_{1} - {h}_{2} ) k$$

$${x}_{27} = {x}_{1} + \frac{1}{2} ( {h}_{1} - {h}_{2} ) i - \frac{1}{2} ( {h}_{1} - {h}_{2} ) j - \frac{1}{2} ( {h}_{1} - {h}_{2} ) k$$

$${x}_{28} = {x}_{1} - \frac{1}{2} ( {h}_{1} - {h}_{2} ) i - \frac{1}{2} ( {h}_{1} - {h}_{2} ) j - \frac{1}{2} ( {h}_{1} - {h}_{2} ) k$$

Any physical quantity A₂ₛ of the s-th calculation particle 20s after the division can be given by the following expression, for example, using the gradient of the physical quantity A₁ of the calculation particle 20 before the division.

A₂ₛ=A₁+∇A₁·(x₂ₛ−x₁) (37)

Here, the physical quantities A₂ₛ and A₁ correspond to the physical quantities on the left side of the governing equations of Expressions (18) to (22).

Even when the analysis space is two-dimensional, the positions of the calculation particles 20 and the physical quantities of the calculation particles 20 after the division can be obtained by the same method.

When it is determined in step SC1 (FIG. 6) that the spatial resolution is excessive, it is determined whether or not there is a partner particle forming a closest pair (step SC2). The “closest pair” means a pair of calculation particles 20 having a closest relationship with each other.

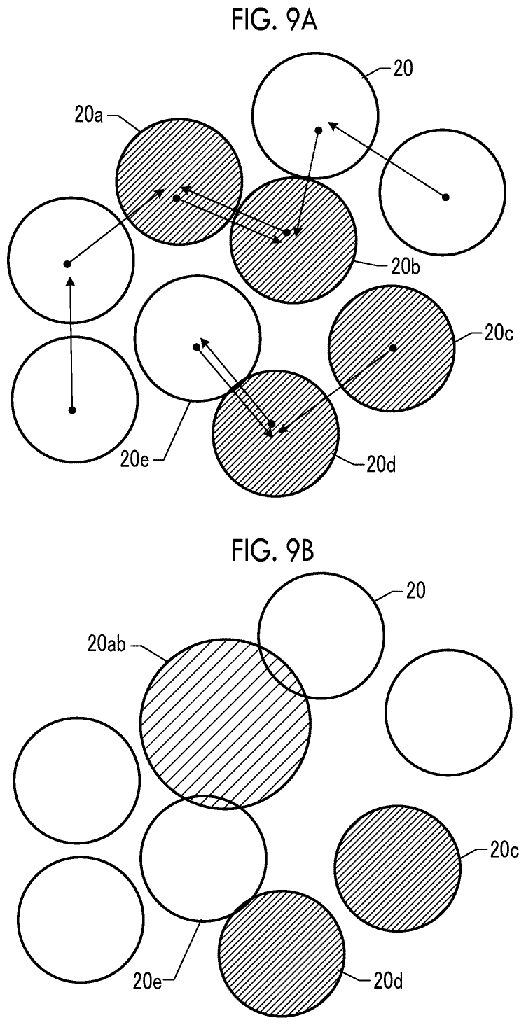

The closest pair will be specifically described with reference to FIG. 9A. FIG. 9A is a schematic diagram showing an example of the distribution of the plurality of calculation particles 20. An arrow shown in FIG. 9A points from each of the calculation particles 20 toward the closest calculation particle 20. For example, the closest particle of the calculation particle 20a is the calculation particle 20b, and the closest particle of the calculation particle 20b is the calculation particle 20a. Therefore, the two calculation particles 20a and 20b form a closest pair.

The closest particle of the calculation particle 20c is the calculation particle 20d. However, the closest particle of the calculation particle 20d is the calculation particle 20e, and is not the calculation particle 20c. Therefore, the calculation particle 20c does not form a closest pair with another calculation particle 20. The closest particle of the calculation particle 20e is the calculation particle 20d. Therefore, the calculation particles 20d and 20e form a closest pair.

In a case where it is determined in step SC2 (FIG. 6) that there is a partner calculation particle 20 forming the closest pair, it is determined whether or not the spatial resolution of the partner particle forming the closest pair is excessive (step SC3). When the spatial resolution of the partner particle is determined to be excessive, two calculation particles 20 forming the closest pair are combined (step SC4), and one large calculation particle having a kernel width larger than the kernel width of either of the two calculation particles 20 is generated. That is, when the spatial resolutions of the two calculation particles 20 forming the closest pair are both excessive, the two calculation particles 20 are combined.

Among the calculation particles 20 shown in FIG. 9A, the calculation particles 20a, 20b, 20c, and 20d are determined to have an excessive spatial resolution, and the other calculation particles 20 are not determined to have an excessive spatial resolution. In FIG. 9A, the calculation particles 20a, 20b, 20c, and 20d determined to have an excessive spatial resolution are hatched.

Since the calculation particles 20a and 20b forming the closest pair are both determined to have an excessive spatial resolution, the calculation particles 20a and 20b are combined. The calculation particles 20d and 20e forming the closest pair are not combined with each other because the spatial resolution of one of the calculation particles 20e is not excessive.

FIG. 9B is a schematic diagram showing an example of the distribution of the calculation particles 20 after the calculation particles 20a and 20b are combined. The calculation particles 20a and 20b are combined to generate a large calculation particle 20ab. In FIG. 9B, the calculation particles 20ab after combination are relatively lightly hatched.

Next, a method of combining the two calculation particles 20 will be described.

With respect to one calculation particle 20a before combination, the position is marked as x₁₁, the kernel width is marked as h₁₁, the mass is marked as m₁₁, and the volume is marked as V₁₁. With respect to the other calculation particle 20b, the position is marked as x₁₂, the kernel width is marked as h₁₂, the mass is marked as m₁₂, and the volume is marked as V₁₂. The mass m₂ and the kernel width h₂ of the calculation particles 20ab (FIG. 9B) after combination can be calculated using the following expressions.

m₂=m₁₁+m₁₂

h₂=(V₁₁+V₁₂)^{1/3} (38)

The position x₂ of the calculation particle 20ab after the combination can be determined by the following expression using the weighted average values based on the mass at the positions x₁₁ and x₁₂ of the two calculation particles 20a and 20b before the combination.

$${x}_{2} = \frac{{m}_{11} {x}_{11} + {m}_{12} {x}_{12}}{{m}_{11} + {m}_{12}} \qquad ( 39 )$$

Any physical quantity A₂ of the calculation particles 20ab after combination can also be similarly calculated by the following expression using the physical quantities A₁₁ and A₁₂ of the calculation particles 20a and 20b before combination.

$${A}_{2} = \frac{{m}_{11} {A}_{11} + {m}_{12} {A}_{12}}{{m}_{11} + {m}_{12}} \qquad ( 40 )$$

Alternatively, the calculation may be performed by, for example, the following expression using the physical quantities A₁₁ and A₁₂ of the calculation particles 20a and 20b before combination and the gradients of these physical quantities.

$${A}_{2} = \frac{1}{2} ( {A}_{11} + ∇ {A}_{11} \cdot ( {x}_{2} - {x}_{11} ) + {A}_{12} + ∇ {A}_{12} \cdot ( {x}_{2} - {x}_{12} ) ) \qquad ( 41 )$$

For all the calculation particles 20, the procedures from step SC1 are repeated until the process for adjusting the spatial resolution is completed (step SC7).

Next, the excellent effects of the present embodiment will be described.

In the present embodiment, since the excess or deficiency of the spatial resolution is evaluated in step SA5 shown in FIG. 2, and the spatial resolution is adjusted in step SA6, the analysis can be performed with an appropriate spatial resolution over the entire area in the analysis space. For example, analysis is performed with a high spatial resolution in the vicinity of the wall surface, and sufficient information regarding the flow field can be obtained. Further, in a region far from the wall surface, the analysis is performed with a relatively low spatial resolution, so that the calculation load can be reduced.

As a method of performing analysis at a spatial resolution that differs depending on a place in the analysis space, a method of dividing the analysis space into a plurality of regions having different spatial resolutions and disposing calculation particles having different sizes in respective divided regions is conceivable. However, in this method, it is necessary to perform a process of exchanging physical quantities between the divided regions, and the calculation load of this process is large. When the number of divisions is increased, the calculation load becomes even larger. Further, in a complicated flow field, when the calculation particle moves across the divided region, an inconsistency arises in the law of conservation of mass, and the analysis may become numerically unstable. Further, since the analysis space is divided manually by the operator, there is a possibility that an inappropriate spatial resolution is set depending on the skill of the operator.

On the other hand, in the present embodiment, since the analysis space is not divided into a plurality of regions, the above-described problems do not occur.

In the present embodiment, the thresholds that are the criteria for determination in steps SB4 and SB8 shown in FIG. 4 are set to 10 and 2.5, and the thresholds that are the criteria for determination in steps SB5 and SB9 are set to 3 and 1, but other values may be used as these thresholds. However, it is preferable to set a threshold that is a criterion for determining excessive spatial resolution to be smaller than a threshold that is a criterion for determining insufficient spatial resolution, and to provide a difference between the two thresholds. By setting the threshold in this way, it is possible to prevent the calculation particle 20 from frequently repeating the division and the combination.

Further, when the calculation particles 20 are repeatedly divided and combined during a small number of time steps, the distribution of the plurality of calculation particles 20 satisfying the analysis space 10 (FIG. 3) becomes inconsistent, and the calculation may be numerically unstable. In order to avoid this, it is preferable to perform the process of adjusting the spatial resolution (step SA6) at a somewhat long time interval. When the number of time steps corresponding to this time interval is marked as Nᵣ, the maximum kernel width is marked as hₘₐₓ, the representative sound velocity of the fluid is marked as c₀, and the time step width of the calculation is marked as Δt, the number Nᵣ of time steps may be set as follows.

$${N}_{r} = α \frac{{h}_{max}}{{c}_{0} Δ t} \qquad ( 42 )$$

Here, the maximum kernel width hₘₐₓ and α are any parameters, the maximum kernel width hₘₐₓ can be set to, for example, a value of about 1/10 or more and 1/30 or less of the representative length of the flow field, and α can be set to 10, for example.

### Reduction of Errors Associated with Division and Combination of Calculation Particles

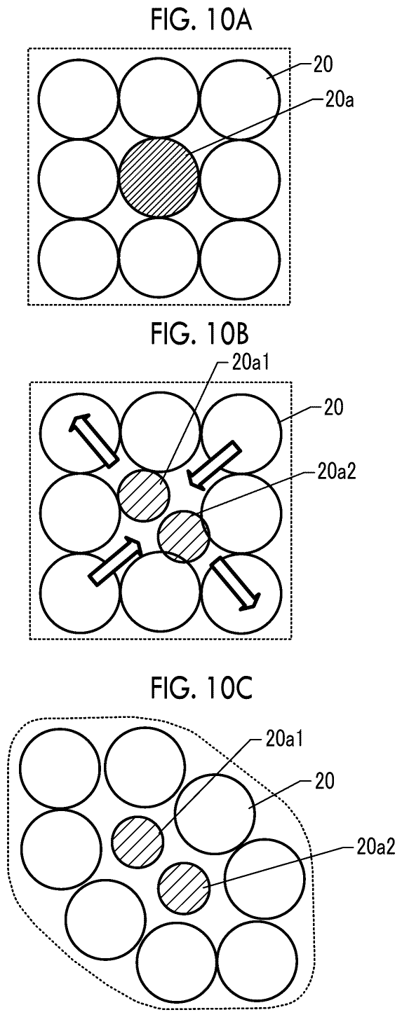

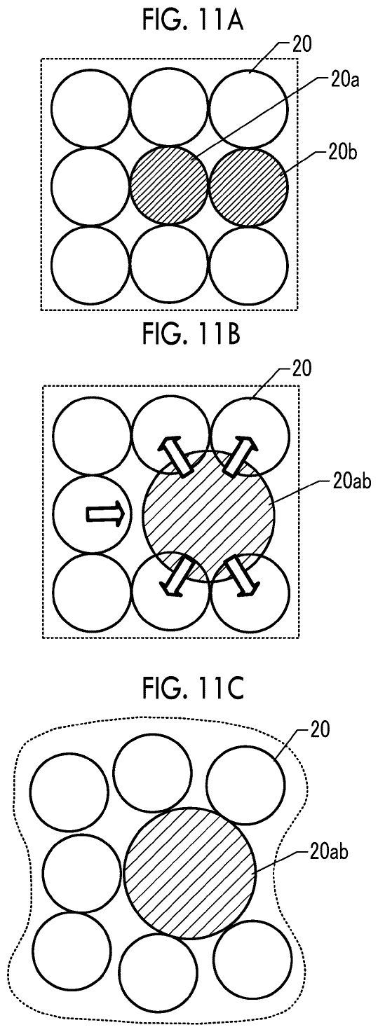

Next, a method of reducing an error that may occur due to the division and combination of the calculation particles 20 will be described with reference to FIGS. 10A to 11C.

FIG. 10A is a schematic diagram showing a distribution of the plurality of calculation particles 20 before the calculation particle 20a is divided. In FIG. 10A, the calculation particle 20a to be divided is hatched. In the state before the division, the plurality of calculation particles 20 including the calculation particle 20a are substantially uniformly distributed.

FIG. 10B is a schematic diagram showing a distribution of the plurality of calculation particles 20 after the calculation particle 20a (FIG. 10A) is divided. One calculation particle 20a (FIG. 10A) is divided into two calculation particles 20a1 and 20a2. In FIG. 10B, the two divided calculation particles 20a1 and 20a2 are hatched.

Since one calculation particle 20a (FIG. 10A) is divided into two calculation particles 20a1 and 20a2, the distribution of the plurality of calculation particles 20 including the two calculation particles 20a1 and 20a2 is biased.

FIG. 11A is a schematic diagram showing a distribution of the plurality of calculation particles 20 before the two calculation particles 20a and 20b are combined. In FIG. 11A, the two calculation particles 20a and 20b before combination are hatched. In the state before combination, the plurality of calculation particles 20 including the calculation particles 20a and 20b are substantially uniformly distributed.

FIG. 11B is a schematic diagram showing a distribution of the plurality of calculation particles 20 after the calculation particles 20a and 20b (FIG. 11A) are combined. The two calculation particles 20a and 20b (FIG. 11A) are combined to generate one calculation particle 20ab. In FIG. 11B, the calculation particle 20ab generated by combination is hatched.

Since the two calculation particles 20a and 20b (FIG. 11A) are combined to generate one calculation particle 20ab, the distribution of the plurality of calculation particles 20 including the calculation particle 20ab after combination is biased.

As shown in FIGS. 10B and 11B, when the distribution of the calculation particles 20 is biased, an artificial velocity is added in the direction of eliminating the bias in the distribution in each of the calculation particles 20, due to the action of the artificial translocation term δvᵢ added to Expression (17). The arrows shown in FIGS. 10B and 11B indicate the direction of the artificially applied velocity.

FIG. 10C is a schematic diagram showing a distribution of the plurality of calculation particles 20 at a time when a certain number of time steps have elapsed from the state shown in FIG. 10B. FIG. 11C is a schematic diagram showing a distribution of the plurality of calculation particles 20 at a time when a certain number of time steps have elapsed from the state shown in FIG. 11B. Due to the action of the artificial translocation term δvᵢ in Expression (17), the bias in the distribution of the plurality of calculation particles 20 is eliminated.

The motion of the calculation particles 20 brought about by this artificial translocation term is irrelevant to the fluid motion. Therefore, the bias in the distribution of the calculation particles 20 is eliminated, so that the distribution of the physical quantity originally contained in the flow field is distorted. Hereinafter, a method of reducing this distortion will be described.

The governing equations shown in Expressions (17) to (22) include the Lagrange differential term. In the method described below, the Lagrange differential term is modified to include an artificial translocation term, thereby reducing the distortion of the physical quantity.

In order to reduce the distortion of the physical quantity due to the non-physical motion caused by the artificial translocation term δvᵢ in Expression (17), the Lagrange differential dA/dt including the artificial translocation term is defined by the following expression. Note that DA/Dt is a normal Lagrange differential that does not include the artificial translocation term.

$$\frac{d A}{d t} ≡ \frac{\partial A}{\partial t} + \frac{\partial A}{\partial {x}_{i}} ( {v}_{j} + δ {v}_{j} ) = \frac{D A}{D t} + \frac{\partial A}{\partial {x}_{j}} δ {v}_{i} \qquad ( 43 )$$

Expression (43) means that the physical quantity A is changed in a direction to reduce the change in the physical quantity A observed when the observer moves in the direction of the artificial translocation term δvᵢ in Expression (17).

The second term on the right side of Expression (43) can be rewritten as follows for an any scalar quantity A.

$$\frac{\partial A}{\partial {x}_{i}} δ {v}_{i} = \frac{\partial ( A δ {v}_{i} )}{\partial {x}_{i}} - A \frac{\partial δ {v}_{i}}{\partial {x}_{j}} \qquad ( 44 )$$

The second term on the right side of Expression (43) can be rewritten as follows for an any vector quantity A.

$$\frac{\partial {A}_{i}}{\partial {x}_{j}} δ {v}_{j} = \frac{\partial ( {A}_{i} δ {v}_{j} )}{\partial {x}_{j}} - {A}_{i} \frac{\partial δ {v}_{j}}{\partial {x}_{j}} \qquad ( 45 )$$

When Expressions (17) to (22) are rewritten using Expression (43), the governing equation to be solved by the SPH method is described as follows.

$$\frac{d ρ}{dt} {\vert}_{S} = {[ - ρ \frac{\partial {v}_{i}}{\partial {x}_{i}} - ρ \frac{\partial δ {v}_{i}}{\partial {x}_{i}} + ρ \frac{\partial ( ρδ {v}_{i}}{\partial {x}_{i}} ]}_{S} \qquad ( 47 )$$

$$ρ \frac{{dv}_{i}}{dt} {\vert}_{S} = {[ - \frac{\partial p}{\partial {x}_{i}} + \frac{\partial }{\partial {x}_{j}} [ {σ}_{ij} + {τ}_{ij} ] - ρ {v}_{i} \frac{\partial δ {v}_{j}}{\partial {x}_{j}} + ρ \frac{\partial ( {v}_{i} δ {v}_{j} )}{\partial {x}_{j}} ]}_{S} \qquad ( 48 )$$

$$ρ \frac{du}{dt} {\vert}_{s} = {[ - \frac{\partial {pv}_{i}}{\partial {x}_{i}} + \frac{\partial }{\partial {x}_{j}} [ {v}_{j} {σ}_{ij} + {v}_{j} {τ}_{ij} ] - \frac{\partial }{\partial {x}_{j}} [ - ( \frac{{c}_{p} μ}{Pr} + \frac{{c}_{p} {μ}_{t}}{{Pr}_{t}} ) \frac{\partial T}{\partial {x}_{j}} ] - ρ u \frac{\partial δ {v}_{i}}{\partial {x}_{i}} + ρ \frac{\partial ( u δ {v}_{i} )}{\partial {x}_{i}} ]}_{s} \qquad ( 49 )$$

$$ρ \frac{dk}{dt} {\vert}_{s} = {[ {τ}_{ij} \frac{\partial {v}_{i}}{\partial {x}_{j}} - {β}^{*} ρω k + \frac{\partial }{\partial {x}_{j}} [ ( μ + {σ}_{k} {μ}_{t} ) \frac{\partial k}{\partial {x}_{j}} ] - ρ k \frac{\partial δ {v}_{i}}{\partial {x}_{i}} + ρ \frac{\partial ( k δ {v}_{i} )}{\partial {x}_{i}} ]}_{s} \qquad ( 50 )$$

$$ρ \frac{d ω}{d t} {\vert}_{s} = {[ \frac{γ}{{v}_{t}} {τ}_{ij} \frac{\partial {u}_{i}}{\partial {x}_{j}} - {βρω}^{2} + \frac{\partial }{\partial {x}_{j}} [ ( μ + {σ}_{ω} {μ}_{t} ) \frac{\partial ω}{\partial {x}_{j}} ] + 2 ρ ( 1 - {F}_{1} ) {σ}_{ω2} \frac{1}{ω} \frac{\partial k}{\partial {x}_{j}} \frac{\partial ω}{\partial {x}_{j}} - ρω \frac{\partial δ {v}_{i}}{\partial {x}_{i}} + ρ \frac{\partial ( ω δ {v}_{i} )}{\partial {x}_{i}} ]}_{s} \qquad ( 51 )$$

Expressions (47) to (51) are governing equations obtained by modifying the Lagrange differential terms included in Expressions (18) to (22) to include an artificial translocation term. By solving the governing equations shown in Expressions (46) to (51), the physical quantity changes in the direction in which the distortion of the physical quantity caused by adding the artificial translocation term is corrected. Accordingly, it is possible to reduce the distortion of the physical quantity generated by the division and combination of the calculation particles 20 and the action of the artificial translocation term.

### Time to Evaluate Excess or Deficiency of Spatial Resolution

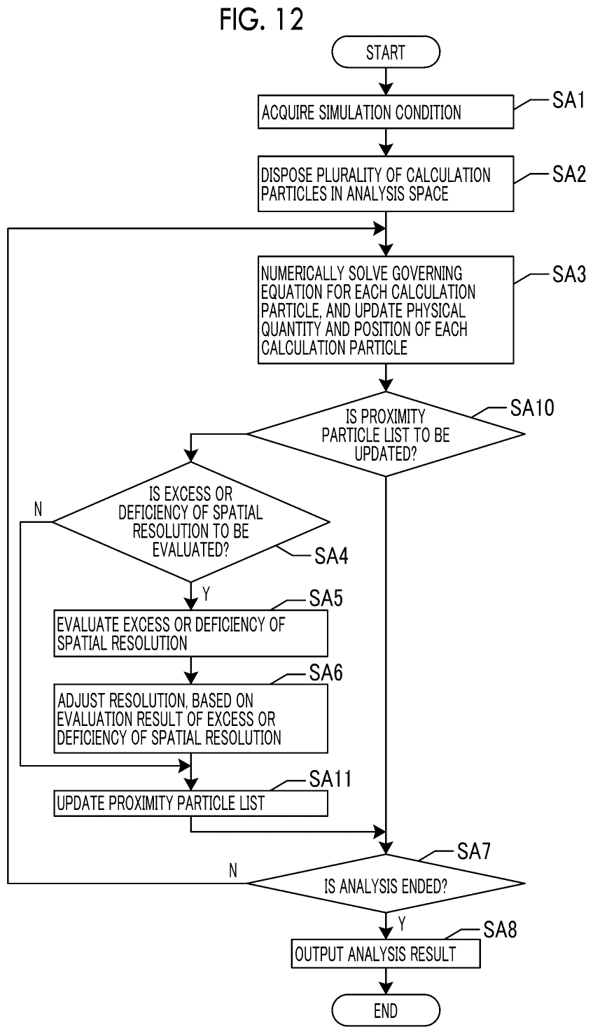

Next, with reference to FIG. 12, a simulation method according to another embodiment in which the time to evaluate the excess or deficiency of the spatial resolution is optimized will be described. FIG. 12 is a flowchart showing procedures of the simulation method according to the present embodiment. Hereinafter, a description will be made focusing on a difference from the flowchart shown in FIG. 2.

In the fluid analysis method using the particle method, analysis using a proximity particle list in which the numbers of other calculation particles 20 existing in the vicinity of the calculation particles 20 are stored for the respective calculation particles 20 is widely used. The process of updating the proximity particle list is executed at regular intervals. As shown in FIG. 12, it is determined at each time step whether or not to update the proximity particle list (step SA10). The proximity particle list is updated in the time step for updating the proximity particle list (step SA11), and the proximity particle list is not updated in the other time steps.

In the method shown in FIG. 2, it is determined whether or not to evaluate the excess or deficiency of the spatial resolution for each time step (step SA4). On the other hand, in the embodiment shown in FIG. 12, it is determined whether or not to evaluate the excess or deficiency of the spatial resolution, before updating the proximity particle list, only at the time step for updating the proximity particle list (step SA4).

The interval for updating the proximity particle list is generally shorter than the number Nᵣ of time steps calculated by Expression (42). In step SA4, it may be determined that the evaluation of the excess or deficiency of the spatial resolution is to be performed, in a case where the number Nᵣ of time steps or more has elapsed from the time when the excess or deficiency of the spatial resolution is most recently evaluated.

After the calculation particles 20 are divided or combined, it is necessary to update the proximity particle list. Therefore, the calculation efficiency can be improved by dividing or combining the calculation particles 20 at the timing of updating the proximity particle list.

### Results Of Actual Simulation

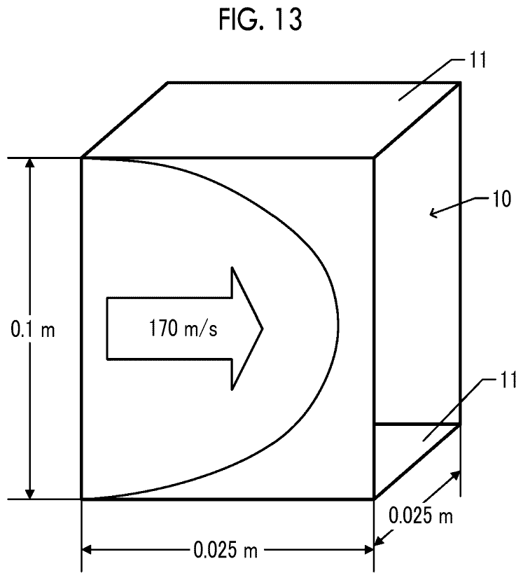

Next, the results of performing the simulation using the simulation method shown in FIG. 12 will be described with reference to FIGS. 13 to 15. For this simulation, the governing equations of Expressions (46) to (51) are used to analyze the flow between the parallel plates.

FIG. 13 is a schematic diagram of the analysis model. The analysis space 10 has a rectangular shape. The dimension in the flow direction (left-right direction in FIG. 13) is 0.025 m, the distance between the pair of parallel wall surfaces 11 (dimension in the height direction in FIG. 13) is 0.1 m, and the dimension in the width direction perpendicular to the flow is 0.025 m. The periodic boundary conditions are imposed as boundary conditions in the flow direction and the width direction. As the boundary condition of the wall surface 11, a non-slip condition is given.

An initial value of a kernel width of the calculation particles 20 is set to 0.005 m, and a plurality of calculation particles 20 are disposed at equal intervals in the analysis space 10. Assuming air as the working fluid, an initial value of temperature of 293 K and an initial value of pressure of 101.3 kPa are applied to all the calculation particles 20 in the analysis space 10. As the initial condition of the velocity, an initial value of the velocity was given to each of the calculation particles 20 according to the distance from the wall surface 11 such that the average flow velocity has a parabolic distribution of 170 m/s. The viscosity coefficient is calculated using Sutherland's law, and a value 100 times that value is given. During the analysis, a pressure gradient is applied in the flow direction such that the average velocity of the flow field is 170 m/s.

The time step width of the analysis was set to 7.28×10⁻⁷ s. The time 0 s is set as the initial state, the flow field is developed over time, and the value of the velocity distribution at the time 0.1 s is output. In addition, as a comparison target, an analysis is also performed in which the kernel widths of all the calculation particles 20 are fixed to 0.0005 m in accordance with the maximum spatial resolution required for the analysis.

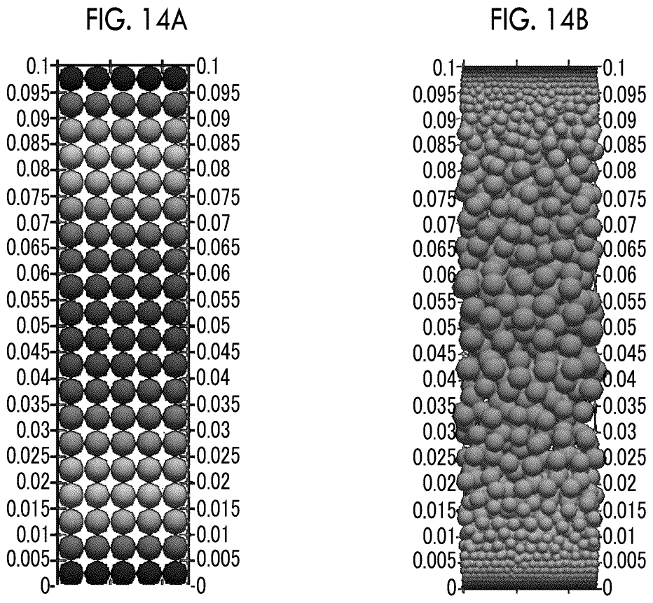

FIGS. 14A and 14B are schematic diagrams showing distributions of calculation particles 20 at a calculation start time and a calculation end time, respectively. At the calculation start time, a plurality of calculation particles 20 having a kernel width of 0.005 m are aligned at equal intervals. At the calculation end time, it can be seen that the finer calculation particles 20 are distributed in the region closer to the wall surface 11. This is because the velocity gradient is large in the vicinity of the wall surface 11, and a higher spatial resolution is required, so that the calculation particles 20 are divided during the calculation, and the size thereof is reduced. At the calculation end time, the number of the calculation particles 20 is approximately 12,000. In a comparative example in which the kernel width of the calculation particles 20 is fixed to 0.0005 m, the number of the calculation particles 20 is approximately 500,000.

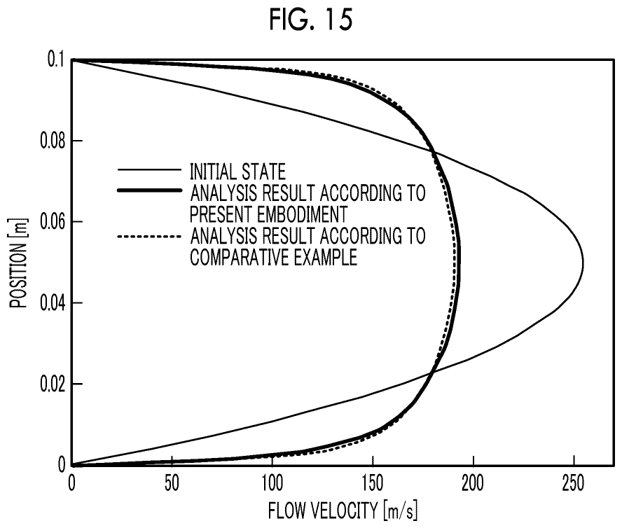

FIG. 15 is a graph showing a velocity distribution at the calculation end time and a velocity distribution in an initial state. In FIG. 15, the horizontal axis represents the flow velocity in the unit [m/s], and the vertical axis represents the distance from one wall surface 11 in the unit [m]. The thin solid line in FIG. 15 indicates the velocity distribution in the initial state, and the thick solid line and the broken line indicate the velocity distributions at the calculation end time obtained by the simulation methods according to the present embodiment and the comparative example, respectively.

It can be seen that the velocity distribution obtained by the simulation method according to the present embodiment is almost the same as the velocity distribution obtained by the simulation method according to the comparative example. That is, in the present embodiment, it is confirmed that the number of the calculation particles 20 can be reduced to about 1/40 as compared with the comparative example, and the analysis can be performed with sufficiently high resolution over the entire flow field.

The above-described embodiment is an example, and the present invention is not limited to the above-described embodiment. For example, it will be apparent to those skilled in the art that various modifications, improvements, combinations, and the like can be made. In the above embodiment, the SPH method is used as the particle method. However, the method according to the above embodiment can also be applied to fluid analysis using another particle method, for example, the MPS method.

It should be understood that the invention is not limited to the above-described embodiment, but may be modified into various forms on the basis of the spirit of the invention. Additionally, the modifications are included in the scope of the invention.

What is claimed is:

1. A simulation method of representing a fluid as a plurality of calculation particles, adding a physical quantity to each of the plurality of calculation particles, disposing the plurality of calculation particles in an analysis space, and developing the physical quantity added to each of the plurality of calculation particles and positions of the plurality of calculation particles over time by solving a governing equation, the simulation method comprising:
evaluating an excess or deficiency of spatial resolution depending on sizes of the plurality of calculation particles, for each of the plurality of calculation particles, according to a state of a flow field represented by the plurality of calculation particles; and
adjusting the spatial resolution, according to a result of the evaluation of the excess or deficiency of the spatial resolution.

2. The simulation method according to claim 1, wherein
the fluid to be analyzed is in contact with a wall surface,
the evaluation of the excess or deficiency of the spatial resolution is performed based on Reynolds number of the flow field or a distance from the wall surface, at a position of each of the plurality of calculation particles, and
the spatial resolution is adjusted by dividing or combining the plurality of calculation particles.

3. The simulation method according to claim 2, further comprising:
adding an artificial translocation term that acts in a direction of reducing distortion in distribution of the plurality of calculation particles, which is generated by dividing or combining the plurality of calculation particles, to the governing equation; and
solving the governing equation to which the artificial translocation term is added, during developing over time.

4. The simulation method according to claim 3, wherein
the governing equation includes a Lagrange differential term, and
a physical quantity is changed in a direction of correcting the distortion of the physical quantity for each of the plurality of calculation particles, which is generated by adding the artificial translocation term, by modifying the Lagrange differential term to include the artificial translocation term and solving the governing equation.

5. A simulation apparatus that analyzes a flow of a fluid using a particle method, the simulation apparatus comprising:
an input unit to which a simulation condition is input; and
a processing unit that develops a position of each of a plurality of particles over time by using the particle method, based on the simulation condition input to the input unit, wherein
the processing unit executes
a procedure of representing the fluid as a plurality of calculation particles, adding a physical quantity to each of the plurality of calculation particles, disposing the plurality of calculation particles in an analysis space, and developing the physical quantity added to each of the plurality of calculation particles and positions of the plurality of calculation particles over time by solving a governing equation,
a procedure of evaluating an excess or deficiency of spatial resolution depending on sizes of the plurality of calculation particles, for each of the plurality of calculation particles, according to a state of a flow field represented by the plurality of calculation particles, and
a procedure of adjusting the spatial resolution, according to a result of the evaluation of the excess or deficiency of the spatial resolution.

6. A non-transitory computer readable medium storing a program that causes a computer to execute a process for simulation that analyzes a flow of a fluid using a particle method, the process comprising:
a procedure of representing the fluid as a plurality of calculation particles, adding a physical quantity to each of the plurality of calculation particles, disposing the plurality of calculation particles in an analysis space, and developing the physical quantity added to each of the plurality of calculation particles and positions of the plurality of calculation particles over time by solving a governing equation;
a procedure of evaluating an excess or deficiency of spatial resolution depending on sizes of the plurality of calculation particles, for each of the plurality of calculation particles, according to a state of a flow field represented by the plurality of calculation particles; and
a procedure of adjusting the spatial resolution, according to a result of the evaluation of the excess or deficiency of the spatial resolution.
